(19) United States
(12) Patent Application Publication
(10) Pub. No.: US 2008/0030452 A1
(43) Pub. Date: Feb. 7, 2008

(54) METHOD AND CIRCUIT FOR CONTROLLING THE VOLTAGE POLARITY OF PIXEL STRUCTURE

(76) Inventors: Chien-Ru Chen, Hsinhua (TW); Ying-Lieh Chen, Hsinhua (TW); Lin-Kai Bu, Hsinhua (TW)

Correspondence Address: PATTERSON & SHERIDAN, L.L.P., 3040 POST OAK BOULEVARD, SUITE 1500, HOUSTON, TX, 77056, US

(21) Appl. No.: 11/462,003

(22) Filed: Aug. 2, 2006

(51) Int. Cl. G09G 3/36

(52) U.S. Cl. 345/96

(57) ABSTRACT

In a pixel array, each column of the pixel array is coupled to one of a plurality of first and second channels of a driver. A first and second control signals are generated. Polarities of the first channels are inversed when a logic level of the first control signal changes and polarities of the second channels are inversed when a logic level of the second control signal changes. Only the logic level of one of the first and second control signals changes in response to each transition of scan periods.

### BACKGROUND OF THE INVENTION

1. Field of the Invention

The present invention relates to a method and circuit for driving a display. More particularly, the present invention relates to a method and circuit for driving an LCD (liquid crystal display) panel using a new inversion scheme.

2. Description of the Related Art

FIG. 1 shows a physical structure 100 of an LCD driving system using COG (chip-on-glass) and WOA (wire-on-array) technology. The structure 100 includes a glass substrate 102 having a pixel array 104 thereon, source drivers 106 mounted on the substrate 102, a PCB (printed circuit board) 112, a system circuit 108 mounted on the PCB 112 and a FPC (flexible printed circuit) board 110 bonded to the PCB 112 and the substrate 102. The system circuit 108 provides power supply voltages, image data and control signals to the source driver circuits 106 through wire lines (not shown) formed on the PCB 108, FPC board 110 and substrate 102.

FIG. 2 shows a conventional dot inversion scheme for driving the pixel array 104 in FIG. 1. For simplicity, only a 4×4 array is shown. Within one single frame, the polarities of any two adjacent pixels are opposite to each other. Moreover, the polarities of each pixel in two adjacent frames are also opposite to each other.

FIG. 3 shows the timing of the control signals in response to which the source driver circuits 106 perform the polarity inversion in the conventional dot inversion scheme. The signal TP has pulses upon every transition of scan periods. The logic level of the signal POL changes upon the rising edges of the signal TP. The source driver circuits 106 inverses the polarities of all their channels in response to the change of the logic level of the signal POL. Thus, a large peak current is drawn from the power supply upon transitions of any two scan periods. Due to limited number of wire lines for power transmission in the structure as shown in FIG. 1, this large current results in a significant variation of the ground level of the driving system. Such a variation of the ground level will lead to errors in logic levels and therefore malfunction of the driving system.

### SUMMARY OF THE INVENTION

It is therefore an objective of the present invention to provide a voltage polarity controlling method and a circuit to control the voltage polarities of pixel structures in a flat panel display.

It is another objective of the present invention to provide a voltage polarity control method and circuit to stabilize the ground level in a flat panel display.

According to one preferred embodiment, in a pixel array, each column of the pixel array is coupled to one of a plurality of first and second channels of a driver. A first and second control signals are generated. Polarities of the first channels are inversed when a logic level of the first control signal changes and polarities of the second channels are inversed when a logic level of the second control signal changes. Only the logic level of one of the first and second control signals changes in response to each transition of scan periods.

According to another preferred embodiment, a pixel array has a plurality of first and second channels coupled to each column of the pixel array. The circuit comprises means for generating a first and second control signals; and means for inversing polarities of the first channels when a logic level of the first control signal changes and inversing polarities of the second channels when a logic level of the second control signal changes. Only the logic level of one of the first and second control signals changes in response to each transition of scan periods.

### BRIEF DESCRIPTION OF THE DRAWINGS

These and other features, aspects and advantages of the present invention will become better understood with regard to the following description, appended claims and accompanying drawings, where:

FIG. 1 shows a physical structure 100 of an LCD driving system using COG (chip-on-glass) and WOA (wire-on-array) technology;

FIG. 2 shows a conventional dot inversion scheme for driving the pixel array 104 in FIG. 1;

FIG. 3 shows the timing of the control signals in response to which the source driver circuits 106 perform the polarity inversion in the conventional dot inversion scheme;

FIG. 4 shows an inversion scheme for driving the pixel array of an LCD according to one embodiment of the invention;

FIG. 5 shows the timing of the control signals in response to which the source driver circuits perform the polarity inversion in the inversion scheme shown in FIG. 4;

FIG. 6 shows a circuit for generation of the control signals POLA and POLB shown in FIG. 5; and

FIG. 7 shows an alternative circuit for generation of the control signals POLA and POLB shown in FIG. 5.

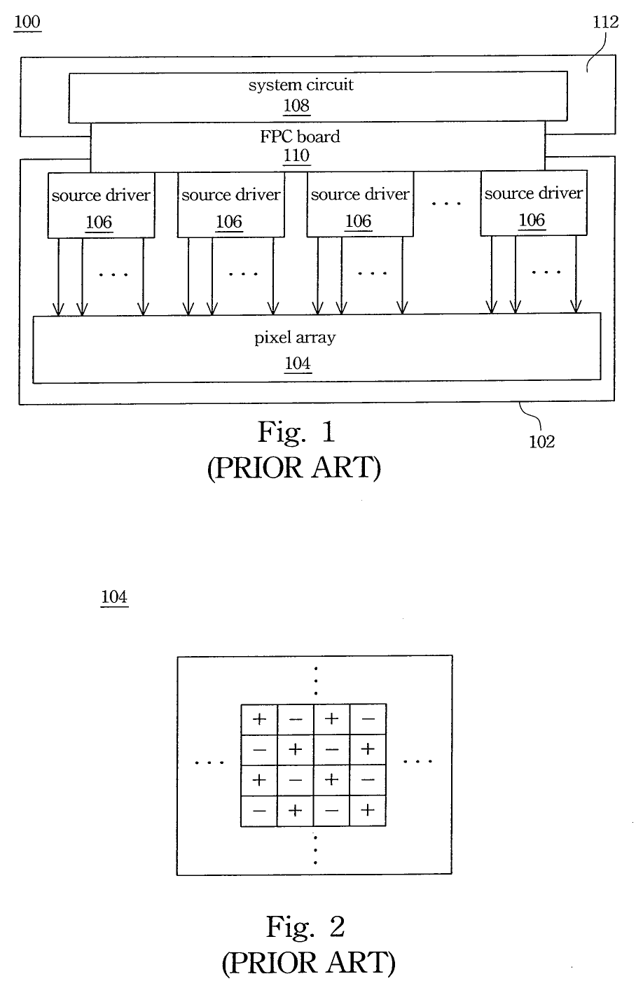

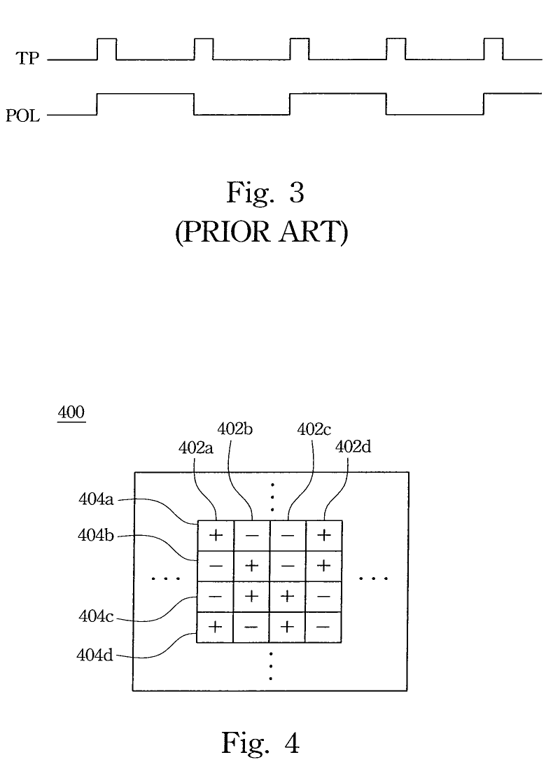

### DETAILED DESCRIPTION

Reference will now be made in detail to the preferred embodiments of the present invention, examples of which are illustrated in the accompanying drawings. Wherever possible, the same reference numbers are used in the drawings and the description to refer to the same or like parts.

FIG. 4 shows an inversion scheme for driving the pixel array of an LCD according to one embodiment of the invention. For simplicity, only a 4×4 array is shown. Within one single frame, only the polarities of the pixels of some columns in one row are opposite to the polarities of the pixels of those columns in an adjacent row. More specifically, within one single frame, the polarities of the pixels of the (4n−3)^{th} and (4n−2)^{th} columns in the (2m−1)^{th} row are opposite to the polarities of the pixels of the (4n−3)^{th} and (4n−4n−2)^{th} columns in the (2m)^{th} row while the polarities of the pixels of the (4n−1)^{th} and (4n)^{th} columns in the (2m−1)^{th} row are the same as the polarities of the pixels of the (4n−1)^{th} and (4n)^{th} columns in the (2m)^{th} row, and the polarities of the pixels of the (4n−3)^{th} and (4n−2)^{th} columns in the (2m)^{th} row are the same as the polarities of the pixels of the (4n−3)^{th} and (4n−2)^{th} columns in the (2 m+1)^{th} row while the polarities of the pixels of the (4n−1)^{th} and (4n)^{th} columns in the (2m)^{th} row are opposite to the polarities of the pixels of the (4n−1)^{th} and (4n)^{th} columns in the (2 m+1)^{th} row, wherein n and m are natural numbers.

For example, the polarities of the pixels of the 1st and 2nd columns 402a and 402b in the 1st row 404a are opposite to the polarities of the pixels of the same columns in the 2nd row 404b while the polarities of the pixels of the 3^{rd} and 4^{th} columns 402c and 402d in the 1 st row 404a are the same as the polarities of the pixels of the 3^{rd} and 4^{th} columns 402c and 402d in the 2nd row 404b, and the polarities of the pixels of the 1st and 2nd columns 402a and 402b in the 2nd row 404b are the same as the polarities of the pixels of the same columns in the 3^{rd} row 404c while the polarities of the pixels of the 3^{rd} and 4^{th} columns 402c and 402d in the 2nd row 404b are opposite to the polarities of the pixels of the 3^{rd} and 4^{th} columns 402c and 402d in the 3^{rd} row 404c.

Moreover, in the previously described inversion scheme, the polarities of each pixel in two adjacent frames are also opposite to each other.

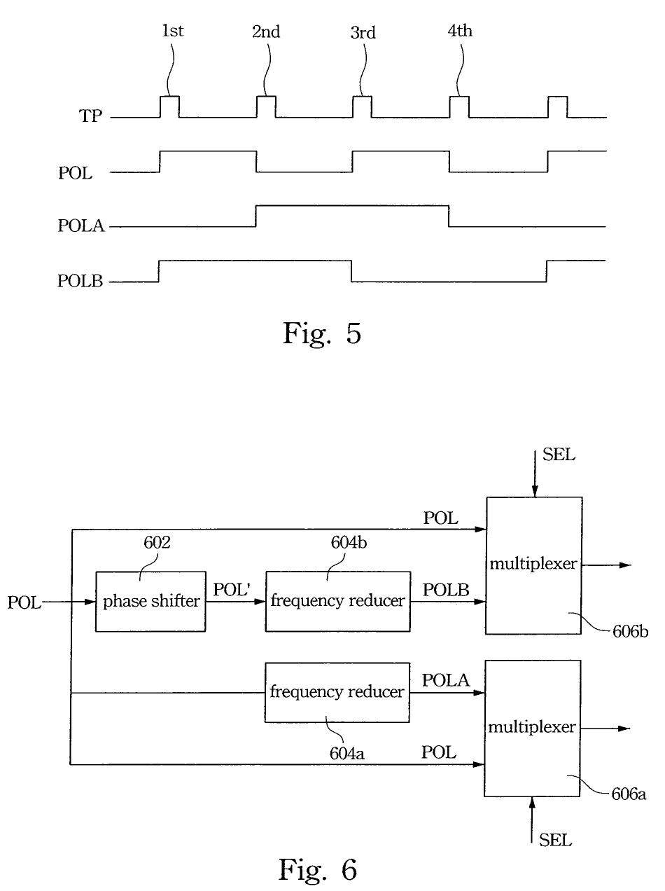

FIG. 5 shows the timing of the control signals in response to which the source driver circuits perform the polarity inversion in the inversion scheme shown in FIG. 4. The signal TP has pulses upon every transition of scan periods. The logic level of the signal POL changes upon the rising edges of the signal TP. The logic level of the signal POLA changes upon the falling edges of the signal POL while the logic level of the signal POLB changes upon the rising edges of the signal POL. All the source driver circuits inverse the polarities of the channels coupled to the pixels of the (4n−3)^{th} and (4n−2)^{th} columns in response to the change of the logic level of the signal POLA while they inverse the polarities of the channels coupled to the pixels of the (4n−1)^{th} and (4n)^{th} columns in response to the change of the logic level of the signal POLB. For example, all the source driver circuits inverse the polarities of the channels coupled to the pixels of the 1st and 2nd columns in response to the change of the logic level of the signal POLA while they inverse the polarities of the channels coupled to the pixels of the 3^{rd} and 4^{th} columns in response to the change of the logic level of the signal POLB.

Moreover, the logic level of the signal POLA changes in response to the transition of the (2m−1)^{th} and (2m)^{th} scan periods while the logic level of the signal POLB changes in response to the transition of the (2m)^{th} and (2m+1)^{th} scan periods, wherein m is a natural number. For example, the logic level of the signal POLA changes in response to the transition of the 1st and 2nd scan periods while the logic level of the signal POLB changes in response to the transition of the 2nd and 3^{rd} scan periods. Thus, the logic levels of signals POLA and POLB do not change simultaneously so that, in response to each transition of scan periods, the source driver circuits do not inverse the polarities of all their channels, which reduces the peak current resulting from the polarity inversion.

FIG. 6 shows a circuit for generation of the control signals POLA and POLB shown in FIG. 5. The circuit includes a phase shifter 602, frequency reducers 604a and 604b, a phase shifter 604, and multiplexers 606a and 606b. The phase shifter 602 receives the signal POL and outputs a signal POL′ which is delayed by one scan period. The frequency reducers 604a and 604b receive the signal POL and delayed signal POL′, and output the signals POLA and POLB whose frequencies are half of the frequency of the signals POL and POL′, respectively. The multiplexer 606a receives the signals POL and POLA, and selectively outputs one of them in response to a selection signal SEL. The multiplexer 606b receives the signals POL and POLB, and selectively outputs one of them in response to the selection signal SEL. Thus, when the selection signal is asserted (or de-asserted), the signals POLA and POLB are transmitted to the source driver circuits, activating the inversion scheme shown in FIG. 4. When the selection signal is de-asserted (or asserted), only the signal is transmitted to the source driver circuits, activating the conventional dot inversion scheme.

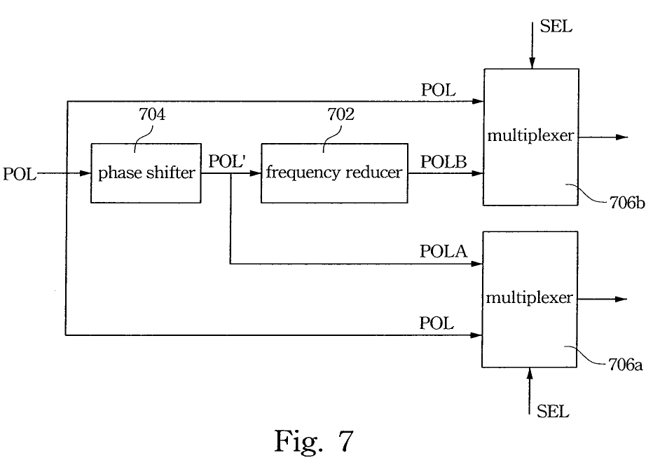

FIG. 7 shows an alternative circuit for generation of the control signals POLA and POLB shown in FIG. 5. The circuit includes a frequency reducer 704, a phase shifter 702, and multiplexers 706a and 706b. The frequency reducer 704 receives the signals POL and output a frequency-reduced signal POL′ whose frequencies ares half of the frequency of the signals POL. The phase shifter 702 receives and delays the signal POL by one scan period to generate the signal POLB. The multiplexer 706a receives the signals POL and POLA (i.e. POL′), and selectively outputs one of them in response to a selection signal SEL. The multiplexer 706b receives the signals POL and POLB, and selectively outputs one of them in response to the selection signal SEL.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A method for driving a pixel array wherein each column of the pixel array is coupled to one of a plurality of first and second channels of a driver, the method comprising the steps of:
generating a first and second control signals; and
inversing polarities of the first channels when a logic level of the first control signal changes and inversing polarities of the second channels when a logic level of the second control signal changes;
wherein only the logic level of one of the first and second control signals changes in response to each transition of scan periods.

2. The method as claimed in claim 1 further comprising the steps of:
generating a third control signal; and
selecting the first and second control signals, or the third control signal; and
if the first and second control signals are selected, inversing the polarities of the first channels when the logic level of the first control signal changes and inversing polarities of the second channels when the logic level of the second control signal changes, and if the third control signal is selected, inversing the polarities of the first and second channels when a logic level of the third control signal changes.

3. The method as claimed in claim 2 wherein the logic level of the third control signal changes in response to each transition of the scan periods.

4. The method as claimed in claim 3 wherein the logic level of the first control signal changes upon falling edges of the third control signal while the logic level of the second control signal changes upon rising edges of the third control signal.

5. The method as claimed in claim 4 wherein the first control signal is generated by reducing a frequency of the third control signal.

6. The method as claimed in claim 4 wherein the second control signal is generated by reducing a frequency of the third control signal and delaying the frequency-reduced signal by one scan period.

7. The method as claimed in claim 4 wherein the second control signal is generated by delaying the third control signal by one scan period and reducing a frequency of the delayed signal.

8. The method as claimed in claim 1 wherein the first channels are coupled to the (4n−3)^{th} and (4n−2)^{th} columns of the pixel array while the second channels are coupled to the (4n−1)^{th} and (4n)^{th} columns of the pixel array, where n is a natural number.

9. The method as claimed in claim 8 wherein the logic level of the first control signal changes in response to the transition of the (2m−1)^{th} and (2m)^{th} scan periods while the logic level of the second control signal changes in response to the transition of the (2m)^{th} and (2m+1)^{th} scan periods, where m is a natural number.

10. A circuit for driving a pixel array having a plurality of first and second channels coupled to each column of the pixel array, the circuit comprising:
means for generating a first and second control signals; and
means for inversing polarities of the first channels when a logic level of the first control signal changes and inversing polarities of the second channels when a logic level of the second control signal changes;
wherein only the logic level of one of the first and second control signals changes in response to each transition of scan periods.

11. The circuit as claimed in claim 10 further comprising:
means for generating a third control signal; and
means for selecting the first and second control signals, or the third control signal; and
means for, if the first and second control signals are selected, inversing the polarities of the first channels when the logic level of the first control signal changes and inversing polarities of the second channels when a logic level of the second control signal changes, and if the third control signal is selected, inversing the polarities of the first and second channels when a logic level of the third control signal changes.

12. The circuit as claimed in claim 11 wherein the logic level of the third control signal changes in response to each transition of the scan periods.

13. The circuit as claimed in claim 12 wherein the logic level of the first control signal changes upon falling edges of the third control signal while the logic level of the second control signal changes upon rising edges of the third control signal.

14. The circuit as claimed in claim 13 wherein the means for generating the first and second control signals comprises:
a frequency reducer generating the first control signal by halving a frequency of the third control signal; and
a phase shifter generating the second control signal by delaying the first control signal by one scan period.

15. The circuit as claimed in claim 14 wherein the means for selecting comprises:
a first multiplexer outputting one of the first and third control signal in response to a selection signal; and
a second multiplexer outputting one of the second and third control signal in response to the selection signal.

16. The circuit as claimed in claim 13 wherein the means for generating the first and second control signals comprises:
a phase shifter delaying the third control signal by one scan period;
a first frequency reducer generating the first control signal by halving a frequency of the third control signal; and
a second frequency reducer generating the second control signal by halving a frequency of the delayed third control signal.

17. The circuit as claimed in claim 16 wherein the means for selecting comprises:
a first multiplexer outputting one of the first and third control signal in response to a selection signal; and
a second multiplexer outputting one of the second and third control signal in response to the selection signal.

18. The circuit as claimed in claim 10 wherein the first channels are coupled to the (4n−3)^{th} and (4n−2)^{th} columns of the pixel array while the second channels are coupled to the (4n−1)^{th} and (4n)^{th} columns of the pixel array, where n is a natural number.

19. The circuit as claimed in claim 18 wherein the logic level of the first control signal changes in response to the transition of the (2m−1)^{th} and (2m)^{th} scan periods while the logic level of the second control signal changes in response to the transition of the (2m)^{th} and (2m+1)^{th} scan periods, where m is a natural number.
